(19) United States
(12) Patent Application Publication
(10) Pub. No.: US 2012/0060562 A1
(43) Pub. Date: Mar. 15, 2012

(54) METHOD FOR PRODUCING THIN SILICON RODS

(75) Inventors: Hanns WOCHNER, Burghausen (DE); Walter HAECKL, Zeilarn (DE)

(73) Assignee: WACKER CHEMIE AG, Muenchen (DE)

(21) Appl. No.: 13/229,098

(22) Filed: Sep. 9, 2011

(30) Foreign Application Priority Data
Sep. 15, 2010 (DE) 10 2010 040 836.0

(51) Int. Cl. C03B 37/15; C03C 25/68; C03B 37/16

(52) U.S. Cl. 65/441; 65/472

(57) ABSTRACT

The invention relates to a method for producing thin silicon rods (1), including the steps: a) providing a rod of polycrystalline silicon, from which at least two thin rods (11, 12) with a reduced cross section in comparison with the polycrystalline silicon rod are separated; b) cleaning the at least two separated thin rods (11, 12) by treatment with a material-eroding liquid medium; c) welding at least two of the cleaned thin rods (11, 12) to form a longer thin rod (1); and d) packaging the longer thin rod (1) in a tubular film (100).

### BACKGROUND OF THE INVENTION

The invention relates to a method for producing thin silicon rods.

Thin silicon rods are used for the deposition of polycrystalline silicon.

Polycrystalline silicon (abbreviation: polysilicon) is used as a starting material for the production of monocrystalline silicon by means of crucible pulling (Czochralski or CZ method) or by means of zone melting (float zone or FZ method). This monocrystalline silicon is cut into wafers and, after a multiplicity of mechanical, chemical and chemical-mechanical processing operations, used in the semiconductor industry to fabricate electronic components (chips).

In particular, however, polycrystalline silicon is required to an increased extent for the production of monocrystalline or polycrystalline silicon by means of pulling or casting methods, this monocrystalline or polycrystalline silicon being used to fabricate solar cells for photovoltaics.

The polycrystalline silicon, often also abbreviated to polysilicon, is conventionally produced by means of the Siemens process. In this case, thin rods of silicon are heated by direct passage of current in a bell-shaped reactor (“Siemens reactor”) and a reaction gas comprising a silicon-containing component and hydrogen is introduced.

The thin silicon rods conventionally have an edge length of from 3 to 15 mm.

As components containing silicon, for example silicon-halogen compounds such as silicon-chlorine compounds, in particular chlorosilanes, are suitable. The component containing silicon is introduced together with hydrogen into the reactor. At temperatures of more than 1000° C., silicon is deposited on the thin rods. This finally provides a rod comprising polycrystalline silicon. DE 1 105 396 describes the basic principles of the Siemens process.

With respect to the production of thin rods, it is known from DE 1 177 119 to deposit silicon on a support body made of silicon (=thin rod), then separate a part thereof and in turn use this separated part as a support body for the deposition of silicon. The separation may be carried out mechanically, for example by means of sawing, or electrolytically by means of a liquid jet.

During the mechanical separation of thin rods, however, their surface becomes contaminated with metals as well as with boron, phosphorus, aluminum and arsenic compounds. The surface contamination with metals is for instance up to 90,000-160,000 pptw (parts per trillion by weight) after mechanical separation. The average pollution with B, P, Al and As lies in the range of from 60 to 700 ppta (parts per trillion atomic).

It is therefore usually necessary to subject the thin rods to surface cleaning before they can be used for the deposition of silicon. In this regard, DE 1 177 119 discloses mechanical cleaning, for example by sandblasting, or chemical cleaning by etching.

By treating the thin rods in an etching tank made of low-contamination material, for example plastic, by means of a mixture of HF and HNO₃, the surface contaminations can be reduced significantly: in the case of metals to as low as 300 pptw or less, and in the case of B, P, Al and As to less than 15 pptw.

EP 0 548 504 A2 describes a cleaning method in which HF and HNO₃ are used to clean silicon.

Another cleaning method is known from DE 195 29 518 A1. In this case, polycrystalline silicon is first cleaned with a mixture of aqua regia (mixture of HCl and HNO₃) and then is subjected to additional cleaning with HF.

EP 0 905 796 A1 discloses a method for producing semiconductor material which has a low metal concentration, characterized in that polycrystalline silicon is washed in precleaning in at least one stage with an oxidizing cleaning solution, is washed in main cleaning in a further stage with a cleaning solution which contains HNO₃ and HF, and during hydrophilization in yet another stage is washed with an oxidizing cleaning liquid. By this cleaning method, the iron and/or chromium content on the surface of the silicon can be reduced from 1.332×10⁻⁸ g/cm² (after processing with a metal tool) to less than 6.66×10⁻¹¹ g/cm².

In order to increase the yield in the silicon deposition, it would also be desirable to be able to use longer thin rods. Longer thin rods can in principle be produced by welding shorter thin rods.

WO 03/070184 A1 describes a method in which two silicon workpieces are joined together crack-free by means of welding. First, the workpieces are heated to a temperature of at least 600° C., preferably on a heating plate made of silicon. The workpieces are then joined together, for example by means of electrical, plasma or laser welding.

For thin workpieces, however, this method is difficult to operate. Furthermore, the silicon workpieces are constantly in direct contact with air during the welding, which is detrimental in respect of contamination.

U.S. Pat. No. 6,573,471 B1 likewise describes a method by which two silicon workpieces can be joined together by welding. The essential difference from the method according to WO 02/070184 A1 is that a reduced pressure of at most 0.05 Torr is set up before the two workpieces are joined.

U.S. Pat. No. 6,852,952 B1 describes a method in which two silicon workpieces are joined together by means of arc welding. To this end, a plasma is generated between two electrodes and the silicon workpieces to be joined are brought into proximity therewith. This is preferably done in an argon atmosphere.

The method according to U.S. Pat. No. 6,852,952 B1 is however also elaborate, and disadvantageous for the welding of thin rods.

Another conceivable method involves induction welding. By means of this, plastic and metal parts are conventionally welded in an air atmosphere.

The use of induction welding to join silicon workpieces would lead to the formation of an SiN layer, since silicon reacts with nitrogen from the ambient air owing to the high temperatures of more than 1500° C. Since SiN does not dissolve in a silicon melt and, as particles, leads to dislocations in the single crystal, the use of such polycrystalline silicon is not suitable for the production of silicon single crystals by means of crucible pulling or zone melting.

For longer thin rods, the currently available etching tanks constitute a further problem.

This is because the size of the etching tanks for cleaning systems made of pure plastic is design-limited. Beyond a certain dimension of the etching tank, the system becomes unstable. Additional steel struts could permit enlargement of the etching tanks. However, the use of steel is critical since it is not possible to preclude the possibility of acid escaping from the etching tank in the vicinity of the steel struts owing to stress cracks, and the acid becoming contaminated with metals.

It was therefore an object of the invention to avoid the disadvantages described above and to improve the prior art.

### SUMMARY OF THE INVENTION

The object is achieved by a method for producing thin silicon rods (1), comprising the steps:

a) providing a rod of polycrystalline silicon, from which at least two thin rods (11, 12) with a reduced cross section in comparison with the polycrystalline silicon rod are separated;
b) cleaning the at least two separated thin rods (11, 12) by treatment with a material-eroding liquid medium;
c) welding at least two of the cleaned thin rods (11, 12) to form a longer thin rod (1);
d) packaging the longer thin rod (1) in a tubular film (100).

The starting point of the method is a rod of polycrystalline silicon, produced by depositing silicon on a thin rod, preferably by means of the Siemens process.

This rod of polycrystalline material is cut into thin rods. Preferably, the separation of the thin rods is carried out mechanically by means of sawing.

The separated thin rods are then chemically cleaned.

Preferably, precisely one cleaning step is carried out before the welding of the thin rods.

This cleaning step is preferably carried out in a cleanroom of cleanroom class 100 or lower (according to US FED STD 209E, superseded by ISO 14644-1).

In class 100 (ISO 5), at most 3.5 particles with a maximum diameter of 0.5 μm may be contained per liter.

The chemical cleaning is preferably carried out by means of an HF/HNO₃ mixture.

The thin rods are then welded.

The welding of the cleaned thin rods is preferably carried out in an inert gas.

The welding is preferably carried out by means of an induction method.

### BRIEF DESCRIPTION OF THE DRAWINGS

The invention will also be explained below with the aid of figures.

FIG. 1 schematically shows the way in which two thin rods are welded.

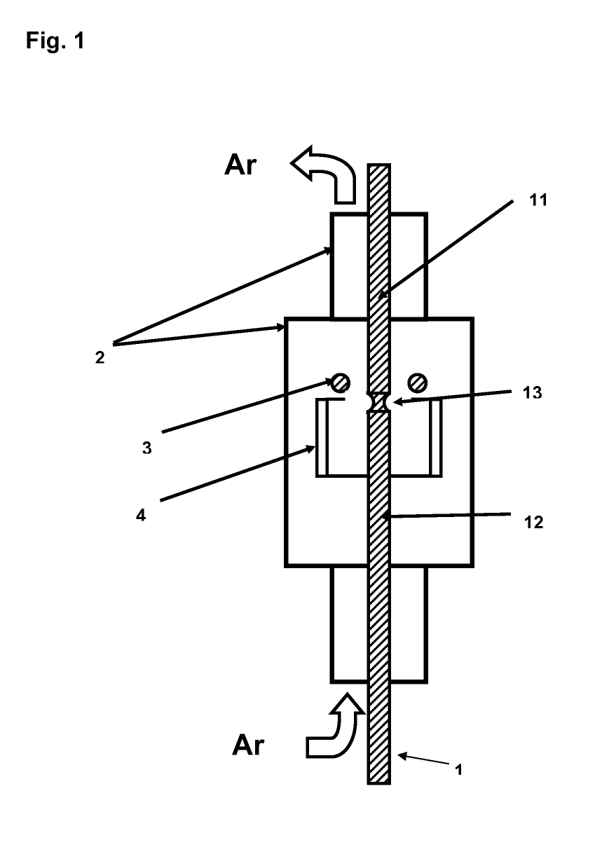

FIG. 2 schematically shows the way in which a welded thin rod is processed in an etching tank.

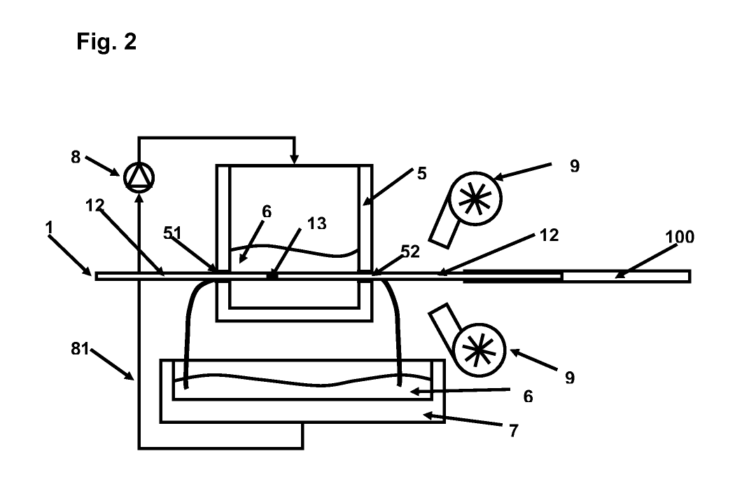

### LIST OF REFERENCES USED

1 welded thin rod
11 first thin rod
12 second thin rod
13 welded joint
2 quartz tube
3 induction coil
4 carbon tube
5 etching container/tank
51 opening
52 opening
6 etching liquid
7 trough
8 pump
81 line
9 drying unit
100 film tube

### DETAILED DESCRIPTION OF PREFERRED EMBODIMENTS

The welding of the short thin silicon rods 11 and 12 is carried out in a device in which the two thin rods 11 and 12 are first brought in contact in a protective gas (particularly preferably argon).

An induction coil 3 heats the two ends of the rods 11 and 12 to above the melting temperature of silicon (>1412° C.) and a drop of liquid silicon is formed, which is held in shape by surface tension. After at most 4 to 5 minutes, the silicon on the ends of the two rods becomes liquid and the induction coil 3 is switched off. The two rods 11 and 12 fuse together.

An induction coil 3 is placed over a quartz-encapsulated tube 4 of carbon (graphite).

The alternating field generated in the induction coil 3 is first coupled into the tube 4 consisting of carbon and heats it. The thermal radiation subsequently heats the silicon rods. Beyond a certain temperature, the alternating field can also be coupled directly into the silicon and heats it further. The actual welding process can now be started.

Temperatures greatly in excess of 1000° C. are set up in the carbon tube 4. It is therefore necessary to ensure that this tube is shielded from the external air. It is expediently encapsulated in quartz. In order to shield the hot silicon from the ambient air as well, the entire device is enclosed by a quartz tube 2. Quartz has, on the one hand, the property that it withstands high temperatures. On the other hand it is transparent, so that it makes it possible to observe the welding process.

The high temperatures inside the quartz tube 2 lead to a comparatively strong convective flow from the bottom upward.

If special measures are not implemented here, ambient air will be sucked in and conveyed to the welding site.

This, however, would entail two disadvantages:
additional pollution of the welding site, and
chemical reactions with the air (nitrogen and oxygen).

The reaction with nitrogen, in particular, is to be avoided under all circumstances since the reaction forms SiN which would cause problems during the subsequent crystal pulling process. The quartz tube is therefore supplied from below with a protective gas (noble gas, argon).

Argon is particularly preferred as a protective gas. In principle, however, other inert gases may also be used.

The protective gas can escape again at the upper opening. The convective flow, which is caused by the high temperature of the silicon, ensures that the ambient air essentially does not come in contact with the hot silicon.

The welded thin rods are subsequently packaged in tubular bags 100.

The packaging of the welded thin rods is preferably carried out in a tubular film of ultrapure PE. The bags used ideally consist of highly pure PE with a thickness of from 40 to 100 μm.

During the welding process, the Si surface is easily contaminated with impurities over the entire thin rod length.

It has been found that thin rods which are obtained by this method can be used both to produce polysilicon for the semiconductor industry (CZ) and for the solar industry.

Polycrystalline silicon which is deposited by deposition on thin rods produced in this way can also be processed further by the zone melting method (FZ) to form single crystals.

The pulling yield for a resistance of less than 1000 ohm·cm is however only less than 50% owing to the impurities which are still present, which is disadvantageous.

Since high-impedance material is increasingly necessary, however, it is preferable to increase the yield. In order to achieve this, it is necessary to reduce the concentration of metals on the Si surface and in the bulk of the thin rod being used, from about 10¹² at/cm² to about 10¹¹ at/cm².

It is known of impurities such as iron, copper and nickel that they drastically reduce the lifetime of the minority charge carriers in silicon. This has negative consequences both for the use of such a material in semiconductor applications (in which case additional getters for metals must then be used) and in solar applications (the lifetime then has a major influence on the efficiency of the solar cell).

An additional cleaning step is therefore preferably carried out immediately before the packaging.

This additional cleaning step is also preferably carried out in a cleanroom with a cleanroom class of 100 or lower.

The second chemical cleaning is also preferably carried out by means of an HF/HNO₃ mixture.

If the welded thin rods are cleaned once more after the welding, then the impurities which have accumulated on the silicon surface of the thin rod during the welding can be removed.

Table 1 shows the surface contamination with metals in pptw after the welding without a second cleaning step.

TABLE 1

| | Fe | Cr | Ni | Na | Zn | Al | Cu | Mo | Ti | W | K | Co | Mn | Ca | Mg | V | Ag |
|---|---|---|---|---|---|---|---|---|---|---|---|---|---|---|---|---|---|
| 25% | 2017 | 43 | 138 | 2908 | 938 | 976 | 77 | 2 | 124 | 14 | 1707 | 7 | 34 | 3849 | 728 | 2 | 11 |
| Quantile | | | | | | | | | | | | | | | | | |
| Median | 2622 | 98 | 170 | 4428 | 2166 | 1260 | 110 | 5 | 218 | 21 | 2395 | 9 | 52 | 4379 | 958 | 3 | 15 |
| Average | 2711 | 123 | 160 | 4551 | 2645 | 1221 | 114 | 15 | 339 | 43 | 2331 | 10 | 56 | 4553 | 978 | 7 | 16 |
| 75% | 3624 | 163 | 185 | 5169 | 4870 | 1667 | 159 | 7 | 305 | 40 | 2698 | 14 | 77 | 6655 | 1389 | 5 | 22 |
| Quantile | | | | | | | | | | | | | | | | | |

Table 2 shows the dopant concentrations in ppta after the welding without a second cleaning step.

TABLE 2

| | B | P | Al | As |
|---|---|---|---|---|
| Median | 109 | 104 | 5 | 11 |
| Average | 132 | 131 | 17 | 18 |

The second chemical cleaning may be carried out with very different etching erosions, as shown in the examples below.

### Example 1

In Example 1, at less than 1 μm, the etching erosion in the second cleaning step is comparatively low.

Conversely, the erosion in the first cleaning step is 30 μm.

The first cleaning step comprises precleaning, main cleaning, a washing step and hydrophilization.

For the precleaning, the thin rod is cleaned for 5 minutes in a mixture of 11 wt % HCl, 5 wt % HF and 1.5 wt % H₂O₂ at a temperature of 20° C.

The main cleaning is carried out for 5 minutes at 8° C. in an HF/HNO₃ mixture containing 6 wt % HF, 55 wt % HNO₃ and 1 wt % Si.

The etching erosion is about 30 μm.

The etched thin rod is subsequently washed for 5 minutes with 18 Mohm ultrapure water heated to 22° C.

Finally, 5 minutes of hydrophilization is carried out in water heated to 22° C. and saturated with 20 ppm of ozone.

Finally, the thin rod is dried for 60 minutes with cleanroom class 100 ultrapure air at 80° C.

The welding of the cleaned thin rods is followed by a second chemical cleaning to remove the particles which have become attached to the silicon surface owing to the welding.

The material erosion is less than 1 μm.

For the precleaning, the thin rod is cleaned for 5 minutes in a mixture of 11 wt % HCl, 5 wt % HF and 1.5 wt % H₂O₂ at a temperature of 20° C.

The main cleaning is carried out for 0.1 minute at 8° C. in an HF/HNO₃ mixture containing 6 wt % HF, 55 wt % HNO₃ and 1 wt % Si.

The etching erosion is about 30 μm.

The etched thin rod is subsequently washed for 5 minutes with 18 Mohm ultrapure water heated to 22° C.

Finally, 5 minutes of hydrophilization is carried out in water heated to 22° C. and saturated with 20 ppm of ozone.

Finally, the thin rod is dried for 60 minutes with cleanroom class 100 ultrapure air at 80° C.

21 thin rods of Example 1 were studied in relation to the contaminations with metals and dopants.

Table 3 shows the surface contamination with metals in pptw for Example 1.

TABLE 3

| | Fe | Cr | Ni | Na | Zn | Al | Cu | Mo | Ti | W | K | Co | Mn | Ca | Mg | V | Ag |
|---|---|---|---|---|---|---|---|---|---|---|---|---|---|---|---|---|---|
| 25% | 9 | 0 | 0 | 4 | 0 | 2 | 0 | 0 | 3 | 0 | 7 | 0 | 0 | 11 | 2 | 0 | 1 |
| Quantile | | | | | | | | | | | | | | | | | |
| Median | 13 | 1 | 0 | 6 | 1 | 4 | 0 | 0 | 4 | 1 | 8 | 0 | 0 | 49 | 6 | 0 | 2 |
| Average | 18 | 1 | 0 | 17 | 2 | 6 | 0 | 0 | 4 | 1 | 10 | 0 | 0 | 101 | 12 | 0 | 3 |
| 75% | 23 | 1 | 0 | 16 | 2 | 7 | 1 | 0 | 5 | 2 | 11 | 0 | 0 | 128 | 13 | 0 | 4 |
| Quantile | | | | | | | | | | | | | | | | | |

Table 4 shows the dopant concentrations in ppta for Example 1.

TABLE 4

| | B | P | Al | As |
|---|---|---|---|---|
| Median | 30 | 25 | 3 | 6 |
| Average | 35 | 32 | 12 | 11 |

Significant reductions can be seen both in the metal contaminations (cf. Table 1) and in the contaminations with B, P, Al and As (cf. Table 2) by virtue of the second cleaning step.

### Example 2

In Example 2, at about 30 μm, the etching erosion in the second cleaning step is significantly higher than in Example 1. The effect of higher etching erosions on the results is to be studied in more detail.

The erosion in the first cleaning step is likewise 30 μm, as in Example 1.

The first cleaning step again comprises precleaning, main cleaning, a washing step and hydrophilization.

For the precleaning, the thin rod is cleaned for 5 minutes in a mixture of 11 wt % HCl, 5 wt % HF and 1.5 wt % H₂O₂ at a temperature of 20° C.

The main cleaning is carried out for 5 minutes at 8° C. in an HF/HNO₃ mixture containing 6 wt % HF, 55 wt % HNO₃ and 1 wt % Si.

The etching erosion is about 30 μm.

The etched thin rod is subsequently washed for 5 minutes with 18 Mohm ultrapure water heated to 22° C.

Finally, 5 minutes of hydrophilization is carried out in water heated to 22° C. and saturated with 20 ppm of ozone.

Finally, the thin rod is dried for 60 minutes with cleanroom class 100 ultrapure air at 80° C.

The welding of the cleaned thin rods is followed by a second chemical cleaning to remove the particles which have become attached to the silicon surface owing to the welding.

The material erosion is about 30 μm.

For the precleaning, the thin rod is cleaned for 5 minutes in a mixture of 11 wt % HCl, 5 wt % HF and 1.5 wt % H₂O₂ at a temperature of 20° C.

The main cleaning is carried out for 5 minutes at 8° C. in an HF/HNO₃ mixture containing 6 wt % HF, 55 wt % HNO₃ and 1 wt % Si.

The etching erosion is about 30 μm.

The etched thin rod is subsequently washed for 5 minutes with 18 Mohm ultrapure water heated to 22° C.

Finally, 5 minutes of hydrophilization is carried out in water heated to 22° C. and saturated with 20 ppm of ozone.

Finally, the thin rod is dried for 60 minutes with cleanroom class 100 ultrapure air at 80° C.

21 thin rods of Example 2 were studied in relation to the contaminations with metals and dopants.

Table 5 shows the surface contamination with metals in pptw for Example 2.

TABLE 5

| | Fe | Cr | Ni | Na | Zn | Al | Cu | Mo | Ti | W | K | Co | Mn | Ca | Mg | V | Ag |
|---|---|---|---|---|---|---|---|---|---|---|---|---|---|---|---|---|---|
| 25% | 4 | 0 | 0 | 2 | 0 | 2 | 0 | 0 | 1 | 0 | 2 | 0 | 0 | 8 | 1 | 0 | 1 |
| Quantile | | | | | | | | | | | | | | | | | |
| Median | 8 | 1 | 0 | 4 | 1 | 4 | 0 | 0 | 2 | 1 | 5 | 0 | 0 | 25 | 4 | 0 | 2 |
| Average | 14 | 1 | 0 | 8 | 2 | 6 | 0 | 0 | 4 | 1 | 7 | 0 | 0 | 55 | 8 | 0 | 3 |
| 75% | 24 | 1 | 0 | 10 | 2 | 7 | 1 | 0 | 5 | 2 | 8 | 0 | 0 | 65 | 9 | 0 | 4 |
| Quantile | | | | | | | | | | | | | | | | | |

Table 6 shows the dopant concentrations in ppta for Example 2.

TABLE 6

| | B | P | Al | As |
|---|---|---|---|---|
| Median | 6 | 9 | 1 | 1 |
| Average | 11 | 12 | 3 | 3 |

Compared with Example 1, an improvement in the contamination can be seen for iron, calcium, magnesium, potassium, sodium, aluminum, titanium and the dopants boron, phosphorus, aluminum and arsenic.

The results of Example 2 show that, with respect to the metal contaminations, higher etching erosions lead to a further slight improvement for iron and the environmental elements calcium, magnesium, potassium, sodium, aluminum, titanium. The concentrations of B, P, Al and As are likewise reduced.

In the scope of the invention, for the preferred second cleaning step, however, low etching erosions of less than 10 μm are preferred. Etching erosions of less than 5 μm are particularly preferred, and etching erosions of less than 2 μm are more particularly preferred.

For the first cleaning of the thin rods, etching erosions of 10 μm or more are preferred. Etching erosions of at least 20 μm are particularly preferred, and etching erosions of at least 30 μm are more particularly preferred.

According to previous experience, the etching tanks for cleaning systems made of pure plastic achieve at most an external length of 4 m and an internal length of 3.2 m. The cleaning of thin rods with a length of more than 3.2 m is therefore not possible with these etching tanks. After the welding of two thin rods, however, the length of the thin rod can reach more than 3.2 m, which requires a different solution for the application of the preferred second cleaning step.

The inventors have discovered that even relatively small etching tanks are suitable for the cleaning of long thin rods.

The previously described brief second step of etching the very long thin rods 1 can particularly preferably be carried out in a tank 5 whose length is less than that of the rod 1. On each of its end faces, this tank 5 has an opening 51 and 52, respectively, through which the longer thin rod 1 can be passed. Etching liquid 6 which flows out along the thin rods 1 at these openings 51 and 52 is collected in a trough 7 placed underneath and pumped back into the etching tank 5 by means of a pump 8 through a line 81, so that there is an equilibrium between the outflow and recycling of the etching liquid 6. After the rod 1 has been passed through the etching tank 5 and the rod 1 has been dried, it can be introduced almost immediately into a film tube 100 for packaging. Further additional pollution is thereby avoided. The drying may be carried out with the aid of hot air from which particles have been removed, and which is blown onto the rod 1. Corresponding drying units are schematically shown by 9.

The forward drive speed of the rod 1 and the length of the etching tank 5 determine the residence time in the etching tank 5 and therefore the etching erosion. The advantage of this method, compared with etching in conventional etching tanks 5, is on the one hand the small space requirement of the system and on the other hand the more flexible structure. Specifically, with the principle presented, it is also possible to produce a cascade of different etching and washing steps, which can be implemented in a very compact structure. Hydrophilization steps can also be carried out without problems in the working sequence.

Grippers such as are used in etching tanks 5 of conventional design, in order to transport the rods 1 from one tank into another, are not required in this method. With this very modular design, it is also possible to introduce simple drying units 9 which dry the thin rod 1 simply with hot air. HF/ozone dryers may also be envisaged, and are particularly advantageous, in which the thin rods 1 are pulled in a final etching bath through a dilute HF/water solution. At the exit from the container opening 51 or 52, there is still an HF/water layer on the thin rod 1, which is blown against the transport direction of the rod 1 by a flow of ozone. Ozone dissolves in the liquid film on the thin rod 1 and changes the surface tension of the film, so that drying according to the Marangoni effect takes place.

The use of longer thin rods, which satisfy particular requirements in terms of impurities, offers the advantage that the yield per run in a deposition reactor can be increased.

The invention therefore makes it possible to produce longer thin rods (>3.2 m) which additionally satisfy stringent requirements of purity. (Pollution less than 10¹² at/cm² or at/cm³)

Thin rods having a length of more than 3.2 m can be produced by joining two or more shorter thin rods to form a longer thin rod.

It has been found that even the use of welded thin rods having a length of less than 3.2 m offers advantages during the deposition process. Evidently, the welding sites modify the stress behavior in the finished rods, so that the rate of collapse when cooling to room temperature in the Siemens reactor, when the reactor is turned off, is significantly reduced. This is an additional unexpected effect of the method according to the invention.

Welding of sawed but not previously cleaned thin rods increases the metal concentration on the surface to more than 10¹⁶ at/cm² at the welding site.

Owing to the high temperature of more than 500° C. during the welding, metallic and other particulate impurities diffuse into the bulk of the thin silicon rod.

Such impurities in the bulk can no longer be removed by surface cleaning.

This is avoided by the method according to the invention and the mandatory cleaning of the thin rods before the welding.

What is claimed is:

1. A method for producing thin silicon rods, comprising the steps:
a) providing a rod of polycrystalline silicon, from which are separated at least two thin rods with a reduced cross section in comparison with the polycrystalline silicon rod;
b) cleaning the at least two separated thin rods by treatment with a material-eroding liquid medium to provide cleaned thin rods;
c) welding at least two of the cleaned thin rods to form a longer thin rod; and
d) packaging the longer thin rod in a tubular film.

2. The method as claimed in claim 1, wherein, after the welding step c) and before the packaging step d), a second cleaning step is carried out, in which the longer thin rod is treated with an additional material-eroding liquid medium.

3. The method as claimed in claim 2, wherein the material-eroding liquid medium and the additional material-eroding liquid medium contain HF and HNO₃.

4. The method as claimed in claim 2, wherein hydrophilization of the thin rods is carried out after cleaning according to step b) and hydrophilization of the longer thin rod is carried out after the second cleaning step using ozone.

5. The method as claimed in claim 2, wherein, in the treatment of the longer thin rod with the additional material-eroding liquid medium, the material erosion is less than 10 μm.

6. The method as claimed in one of claim 1, wherein, in the cleaning of the thin rods by treatment with the material-eroding liquid medium according to step b), the material erosion is respectively at least 10 μm.

7. The method as claimed in claim 2, wherein the second cleaning of the longer thin rod is carried out in a tank, containing the additional material-eroding liquid medium, which on both end faces has an opening, respectively, through which the longer thin rod is passed gradually in order to clean it, the additional material-eroding liquid medium which flows out along the longer thin rod through the openings being collected in a trough arranged below the tank and pumped back into the tank.

8. The method as claimed in claim 7, wherein, after passing the longer thin rod through the tank and drying the longer thin rod, the longer thin rod is introduced into a film tube and packaged.

9. The method as claimed in claim 1, wherein the welding of the at least two separated thin rods to form a longer thin rod is carried out by induction welding in an inert atmosphere.

10. The method as claimed in claim 9, wherein an induction coil arranged over a quartz-encapsulated carbon tube respectively heats one end of the thin rods to above a melting temperature of silicon, so that a drop of liquid silicon is formed, and subsequently the induction coil is switched off and the rods fuse to form the longer thin rod.

11. The method as claimed in claim 3, wherein hydrophilization of the thin rods is carried out after cleaning according to step b) and hydrophilization of the longer thin rod is carried out after the second cleaning step using ozone.

12. The method as claimed in claim 11, wherein, in the treatment of the longer thin rod with the additional material-eroding liquid medium, the material erosion is less than 10 μm.

13. The method as claimed in claim 12, wherein, in the cleaning of the thin rods by treatment with the material-eroding liquid medium according to step b), the material erosion is respectively at least 10 μm.

14. The method as claimed in claim 13, wherein the second cleaning of the longer thin rod is carried out in a tank, containing the additional material-eroding liquid medium, which on both end faces has an opening, respectively, through which the longer thin rod is passed gradually in order to clean it, the additional material-eroding liquid medium which flows out along the longer thin rod through the openings being collected in a trough arranged below the tank and pumped back into the tank.

15. The method as claimed in claim 14, wherein, after passing the longer thin rod through the tank and drying the longer thin rod, the longer thin rod is introduced into a film tube and packaged.

16. The method as claimed in claim 15, wherein the welding of the at least two separated thin rods to form a longer thin rod is carried out by induction welding in an inert atmosphere.

17. The method as claimed in claim 16, wherein an induction coil arranged over a quartz-encapsulated carbon tube respectively heats one end of the thin rods to above a melting temperature of silicon, so that a drop of liquid silicon is formed, and subsequently the induction coil is switched off and the rods fuse to form the longer thin rod.
